(19) United States
(12) Patent Application Publication
(10) Pub. No.: US 2013/0290742 A1
(43) Pub. Date: Oct. 31, 2013

(54) DRIVING SYSTEM AND METHOD FOR A PORTABLE 3.5 INCH EXTERNAL HARD DISK WITHOUT USING AN EXTERNAL POWER

(71) Applicants: Kuang Feng Lin, Taipei City (TW); Yuan Shan Hsu, Taipei City (TW); Wen Hsiang Hsiao, Taipei City (TW)

(72) Inventors: Kuang Feng Lin, Taipei City (TW); Yuan Shan Hsu, Taipei City (TW); Wen Hsiang Hsiao, Taipei City (TW)

(21) Appl. No.: 13/537,053

(22) Filed: Jun. 29, 2012

(30) Foreign Application Priority Data
Apr. 25, 2012 (TW) 101114842
May 31, 2012 (TW) 101119562

(51) Int. Cl. G06F 1/26

(52) U.S. Cl. 713/300

(57) ABSTRACT

A driving system and a driving method for a portable 3.5 inch external hard disk are disclosed. The driving system includes a first power supply module, a second power supply module and the portable 3.5 inch external hard disk. The first power supply module installed in the portable 3.5 inch external hard disk includes a first voltage source having a first output voltage supplies power to a main circuit. The second power supply module includes a second voltage source outputting a first voltage and a second voltage through a first interface output port and a second interface output port, respectively, which are combined to form a second output voltage to supply power to a boost circuit. The boost circuit then outputs a working current to provide to a start circuit, which replaces the first power supply module and hence maintains operation of the external hard disk.

### BACKGROUND OF THE INVENTION

1. Field of the Invention

The present invention generally relates to a driving system and a driving method for a portable 3.5 inch external hard disk without using an external power, and more particularly a driving system and a driving method for a portable 3.5 inch external hard disk using DC battery to start the portable 3.5 inch external hard disk and the desktop computer or notebook by boosting voltage using a USB VBUS power.

2. The Prior Arts

Recently, portable electric devices, such as netbook, tablet PC, Ultrabook, have become more popular. Owing to limited built-in memory volume in these electric devices, most of the customers usually need an external storage device for storing huge digital data or for backup. Thus, the demand of the external storage device like external hard disk has dramatically been growing up.

However, one extra power supply is needed to provide 12V/2 A or 12V/1 A for the requirement of the ultra high speed of the motor in the external hard disk according to improved specification used to sustain preferred transfer effect and data access flow when a file with a great deal of data in the external hard disk is accessed. The portability of such high speed portable hard disks is greatly constrained and therefore, how to improve the portability has become one of the primary issues to resolve for the related industries.

### SUMMARY OF THE INVENTION

A primary objective of the present invention is to provide a driving system for a portable 3.5 inch external hard disk without using an external power. The driving system of the present invention comprises a first power supply module, a second power supply module and the portable 3.5 inch external hard disk. The first power supply module comprises a first voltage source which generates a start current supplying power to a main circuit. The second power supply module includes a second voltage source which outputs a first voltage and a second voltage from a first interface output port and a second interface output port, respectively. The first voltage and the second voltage are combined to output a first working current supplying a boost circuit. The first working current is then outputted to a start circuit. The start circuit starts and replaces the first power supply module. The portable 3.5 inch external hard disk includes the main circuit, a boost circuit and the start circuit, which are electrically connected to the first power supply module and the second power supply module, respectively. Thus, the first power supply module starts the portable 3.5 inch external hard disk circuit through the start current, and a stabilization of the data accessing of the portable hard disk is obtained through the use of the first working current outputted by the boost circuit of the second power supply module replacing the start current flowing into the main circuit.

Therefore, the driving system of the present invention installs the first power supply module inside the portable 3.5 inch external hard disk to implement true portability and mobility for the portable 3.5 inch external hard disk without connecting with electric socket or using a traditional power supply to acquire external power.

Additionally, the present invention can employ DC battery power to drive the portable 3.5 inch external hard disk such that both energy saving and carbon reduction are achieved.

And, the present invention can make the portable 3.5 inch external hard disk perform data accessing just by connecting with the PC device to acquire the electric power desired, as a result of further reducing energy consumption.

Another objective of the present invention is to provide a driving method for a portable 3.5 inch external hard disk without using an external power. The driving method of the present invention includes the steps of:
providing a first power supply module configured within the portable hard disk, wherein the first power supply module comprises a first voltage source which generates an output start current, or wherein the first power supply module comprises a second boost circuit which generates a start current to supply power to a main circuit for starting the portable hard disk;
providing a second power supply module comprising a second voltage source which outputs a first voltage and a second voltage through a first interface output port and a second interface output port, respectively, and the first voltage and the second voltage are combined to form a second output voltage, which supplies power to a boost circuit to form a first working current, which is then provided to a start circuit;
electrically connecting the portable 3.5 inch external hard disk, wherein the portable 3.5 inch external hard disk comprises a start circuit and a main circuit which are electrically connected to the first power supply module and the second power supply module, respectively;
starting the portable 3.5 inch external hard disk, wherein the portable 3.5 inch external hard disk is started by the start current of the first power supply module; and
performing data accessing to the main circuit, wherein the main circuit performs data accessing by the current outputted to the start circuit through the boost circuit from the second power supply module.

Therefore, the driving method of the present invention uses the first power supply module installed in the portable 3.5 inch external hard disk to implement true portability and mobility for the portable 3.5 inch external hard disk without connecting with electric socket or using a traditional power supply to acquire external power.

Additionally, the present invention can utilize DC battery power to drive the portable 3.5 inch external hard disk such that both energy saving and carbon reduction are achieved.

Moreover, the present invention can make the portable 3.5 inch external hard disk can normally operate for data access just by connecting with the PC device to acquire the electric power desired without using any external power supply or transformer to start the portable 3.5 inch external hard disk or implement data access. As a result, it is possible to further reduce energy consumption and implement carbon reduction.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic diagram to illustrate a driving system for a portable 3.5 inch external hard disk without using an external power according to a first preferred embodiment of the present invention;

FIG. 2 shows a schematic diagram to illustrate the driving system according to a second preferred embodiment of the present invention;

FIG. 3 shows a schematic diagram to illustrate the driving system according to a third preferred embodiment of the present invention;

FIG. 4 shows a schematic diagram to illustrate the driving system according to a fourth preferred embodiment of the present invention;

FIG. 5 shows a schematic diagram to illustrate the driving system according to a fifth preferred embodiment of the present invention; and

FIG. 6 shows a flow chart to illustrate the driving method according to the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

The present invention provides a driving system and a driving method for a portable 3.5 inch external hard disk without using an external power, the operation of the hard disk, the data accessing and the operation between electric circuits are well known and thus omitted in the following description. Meanwhile, it is obvious that those elements illustrated in the following figures are only described for the characteristics performed in the present invention, and not intended to be in accordance with the actual physical dimensions.

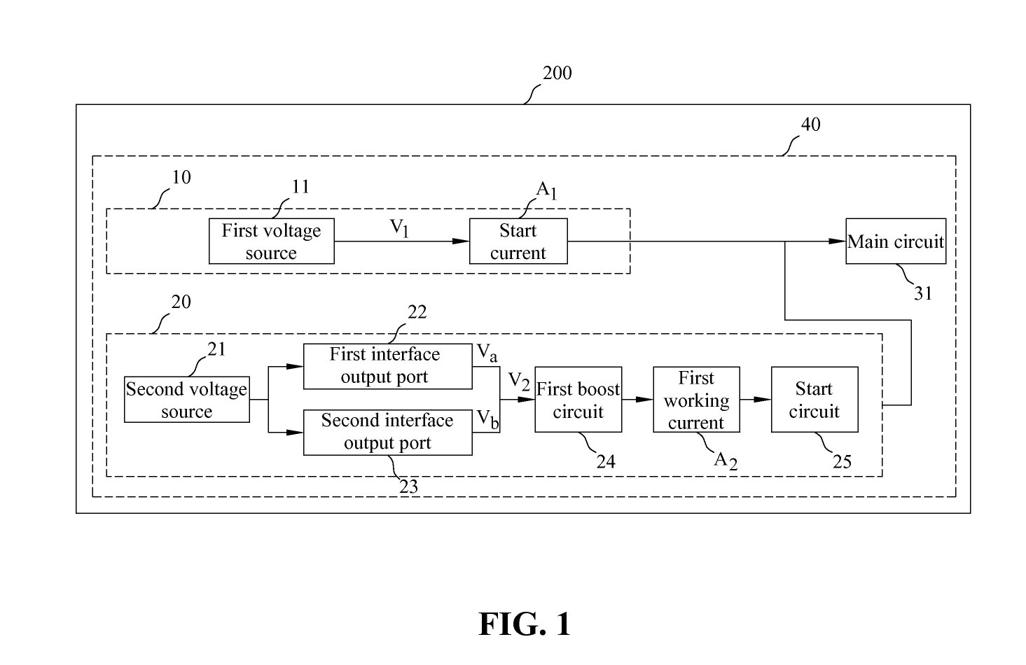

Please refer to FIG. 1. The first preferred embodiment of the present invention provides a driving system for a portable 3.5 inch external hard disk without using an external power. The driving system 200 of the present invention comprises a first power supply module 10 and a second power supply module 20 used to drive the portable 3.5 inch external hard disk 40. The first power supply module 10 installed in the portable 3.5 inch external hard disk 40 includes a first voltage source 11, which generates a first output voltage V₁, and outputs a start current A₁.

The second power supply module 20 includes a second voltage source 21 with a first interface output port 22 and a second interface output port 23 outputting a first voltage Vₐ and a second voltage V_{b}, respectively, which are combined to output a second output voltage V₂ to a first boost circuit 24, which then generates a working current to a start circuit 25 to replace the first power supply module 10.

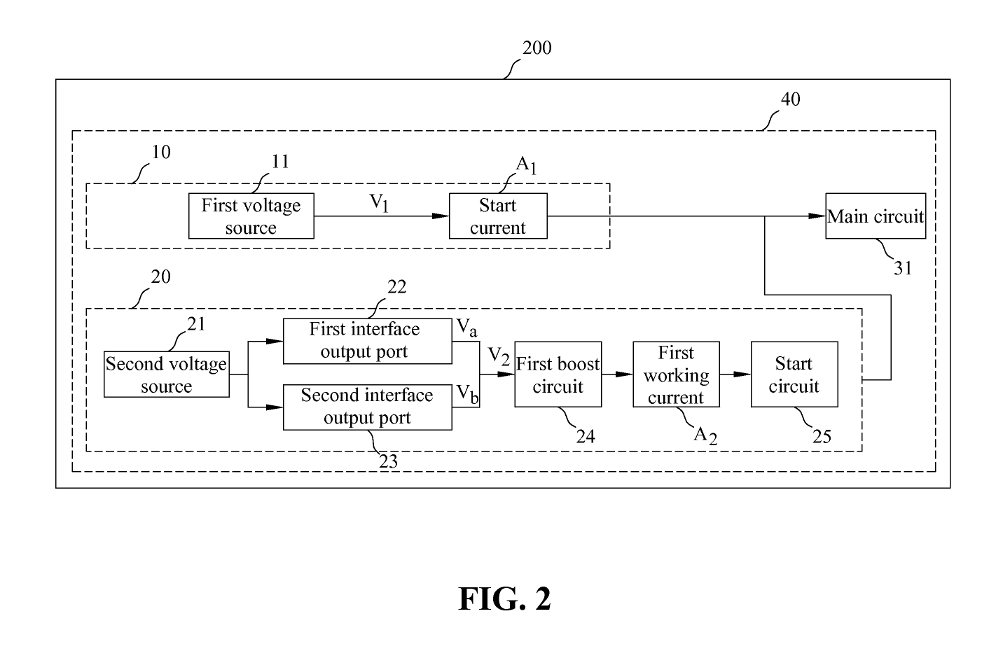

Please refer to FIG. 2, illustrating the second embodiment of the present invention. The first power supply module 10 generates the start current A₁ from the first output voltage V₁ provided by the first voltage source 11. Moreover, the first voltage source 11 can be supplied by a DC rechargeable battery, such as lithium battery, nickel-hydrogen battery or lithium-iron battery. For that, the first output voltage V₁ output from the first voltage source 11 is a DC voltage and within about 11.6 to 13.0V or the corresponding current within about 300 to 400 mA, more preferably, up to 13.0 V or the corresponding current within about 300 to 400 mA. The first power supply module 10 installed in the portable 3.5 inch external hard disk 40 can provide instantaneous high loading current to start the portable 3.5 inch external hard disk 40. The second voltage source 21 of the second power supply module 20 can be supplied by a PC device 120, and the first voltage Vₐ and the second voltage V_{b} output from the first interface output port 22 and the second interface output port 23 are within about 4.5 to 5.5V or the corresponding current within about 0.9 to 2 A, and the first boost circuit 24 is connected to the start circuit 25, thereby stabilizing the first working current A₂.

The portable 3.5 inch external hard disk 40 comprises a main circuit 31 electrically connected with the first power supply module 10 and the second power supply module 20. The main circuit 31 is supplied with the start current A₁ output from the first voltage source 11 so as to start the portable 3.5 inch external hard disk 40. Additionally, the first working current A₂ outputted to the start circuit through the boost circuit from the second voltage source 21 supplies the portable 3.5 inch external hard disk 40 with the current for the continuous operation of the data accessing action.

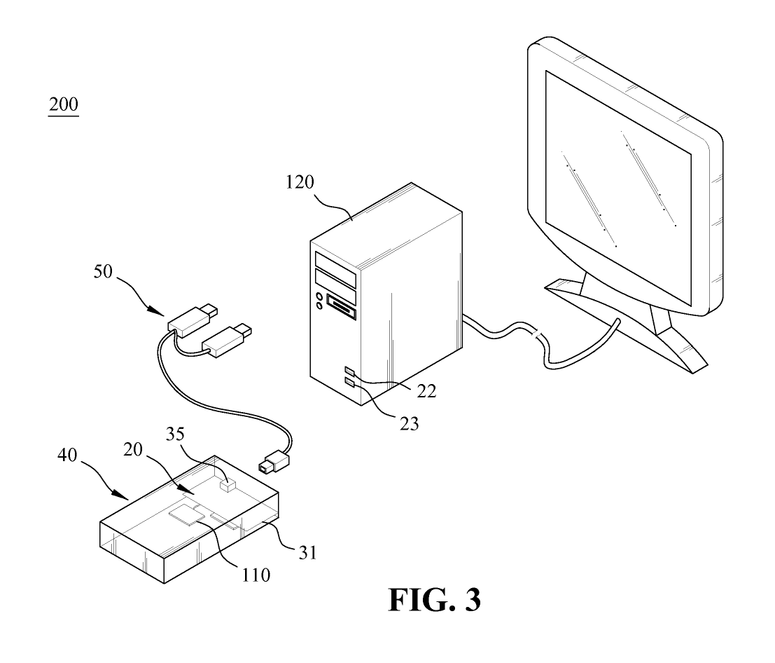

Refer to FIG. 3, illustrating the driving system according to the third preferred embodiment of the present invention. As shown in FIG. 3, the first power supply module 10 is supplied by the DC rechargeable battery 110, and the second power supply module 20 is supplied by the PC device 120. The PC device 120 can be electrically coupled with the portable 3.5 inch external hard disk 40 by use of USB (universal serial bus), and the first interface output port 22 and the second interface output port 23 are USB ports, connected with a USB port 33 of the portable 3.5 inch external hard disk 40 through a Y type USB line 50. For that, the PC device 120 outputs the first voltage Vₐ and the second voltage V_{b} from the first interface output port 22 and the second interface output port 23, which are further combined to the first boost circuit 24 and then outputted to the start circuit 25, thereby replacing the first power supply module 10. The USB line 40 is used to connect to the portable 3.5 inch external hard disk 40 for providing the first working current A₂. Therefore, the driving system of the present invention can utilize the rechargeable battery 110 installed in the portable 3.5 inch external hard disk 40, and does not need to connect to additional socket or use 12 V power supply for external power so as to provide true portability and mobility. In this case, it is possible for the user to carry the Y type USB line 50 and much easier to carry and use the portable 3.5 inch external hard disk 40. Meanwhile, the DC rechargeable battery 110 can be reused for many times and thus provides more environmental protection compared with traditional non-reusable batteries. Also, the first boost circuit 24 can use DC voltage to drive the portable 3.5 inch external hard disk 40 to operate stably for saving electric power and reducing carbon. Additionally, only the power supplied by the PC device 120 is sufficient for the portable 3.5 inch external hard disk 40 to continuously operate and perform data access with the effect of reducing power consumption and carbon load.

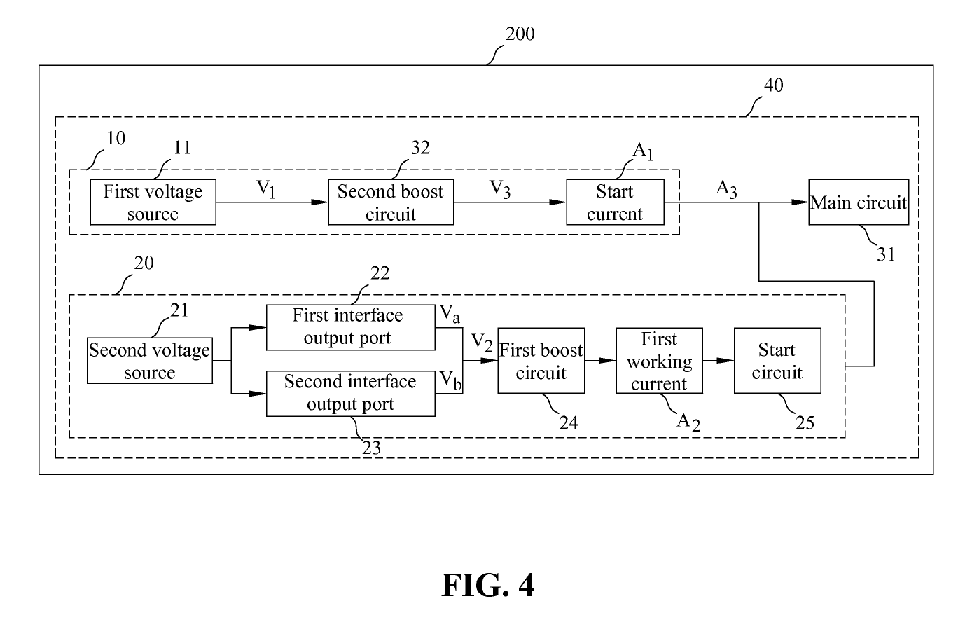

As for the driving system according to the fourth preferred embodiment of the present invention shown in FIG. 4, specifically, the first power supply module 10 is installed in the portable 3.5 inch external hard disk 40 and supplied by the DC rechargeable battery 110, and the second power supply module 20 is supplied by the PC device 120. For that, the first output voltage V₁ outputted from the first voltage source 11 is a DC voltage within about 3.7 to 7.4V, connected with a second boost circuit 32, which boosts up to about 11.6 to 13V and provides the instantaneous high loading current to start the portable 3.5 inch external hard disk 40. Therefore, the second power supply module 20 supplies power to the first voltage source 11 and the main circuit 31, respectively, and when the second power supply module 20 supplies power to the main circuit 31, the first power supply module 10 and the main circuit 31 can respectively receive part of the first working current A₂ outputted from the second power supply module 20. The voltage of the first voltage source 11 is within about 5 to 13V and primarily serves as the power to recharge the DC rechargeable battery 110 of the first voltage source 11. For that, when the portable 3.5 inch external hard disk 40 operates, if the first working current A₂ provided by the second power supply module 20 is insufficient, the DC rechargeable battery 110 immediately provides the first working current A₂ through the second boost circuit 32 so as to compensate the power/current required by the instantaneous high loading such that the main circuit 31 of the portable 3.5 inch external hard disk 40 can keeps normal operating to perform data accessing.

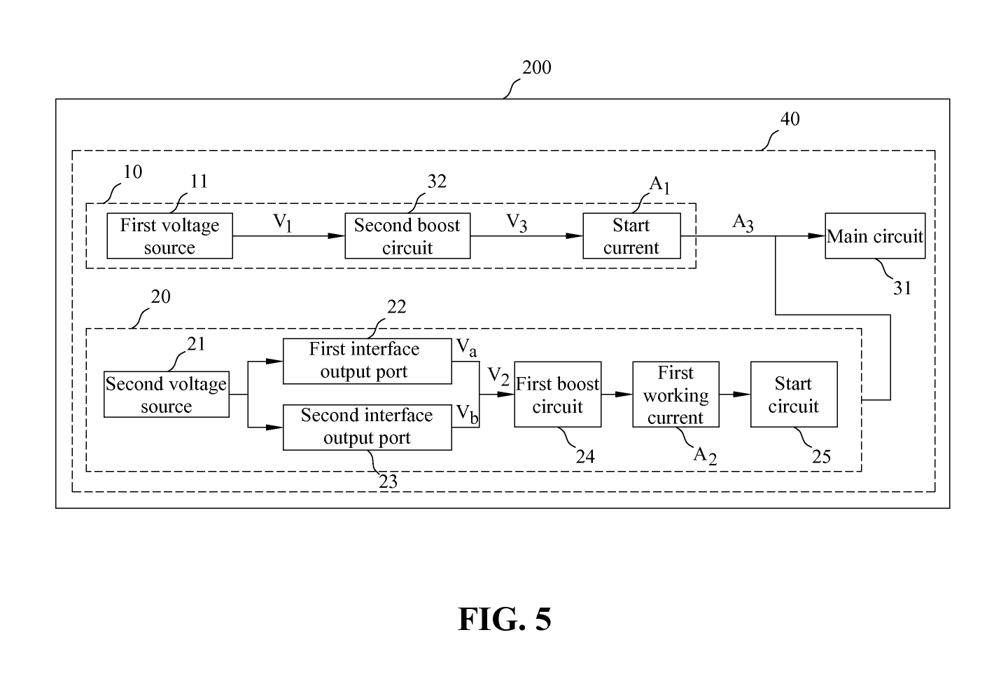

Furthermore, please refer to FIG. 5, illustrating the driving system according to the fifth embodiment of the present invention. Also, the portable 3.5 inch external hard disk 40 may comprise the first boost circuit 24, and the second power supply module 20 respectively supplies power to the main circuit 31 and the first power supply module 10. That is, the main circuit 31 and the first power supply module 10 can receive part of the first working current A₂ provided by the second power supply module 20 and the first boost circuit 24 and the second boost circuit 32 can boost the voltage up to within about 13V, which may supply the current for the main circuit 31 for data accessing. Therefore, more specifically, the first power supply module 10 and the second power supply module 20 can simultaneously be installed in the portable 3.5 inch external hard disk 40 and adjust the current for the main circuit 31 dependent on the actual condition, thereby greatly reducing power consumption.

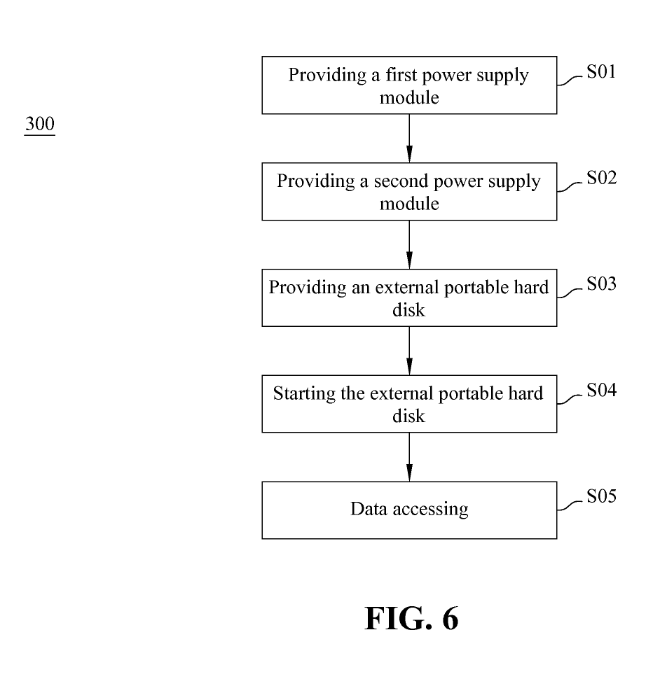

Please refer to FIG. 6, illustrating the driving method for a portable 3.5 inch external hard disk without using an external power according to the present invention. The driving method 300 of the present invention comprises the following steps S01 to S05.

In the step S01, the first power supply module 10 comprising the first voltage source 11 is provided. The first voltage source 11 provides the first output voltage V₁ and the start current A₁ which supplies power to the main circuit 31. Alternatively, the first power supply module 10 may further comprise the second boost circuit 32 generating the start current A₁ and supplying power to the main circuit 31 through a output current A₃. Meanwhile, the first power supply module 10 is installed in the portable 3.5 inch external hard disk 40.

In the step S02, the second power supply module 20 comprising the second voltage source 21 is provided. The second voltage source 21 outputs the first voltage Vₐ and the second voltage V_{b} through the first interface output port 22 and the second interface output port 23, respectively, which are combined to form the output voltage V₂, which is connected to the first boost circuit 24 and then outputted to the start circuit 25. The start circuit 25 then supplies power to the main circuit 31. Thus, the second power supply module 20 replaces the first power supply module 10.

In the step S03, the portable 3.5 inch external hard disk 40 is electrically connected. More specifically, the portable 3.5 inch external hard disk 40 comprises the main circuit 31 which is electrically connected with the first power supply module 10 and the second power supply module 20, respectively.

In the step S04, the portable 3.5 inch external hard disk 40 is started. When the first power supply module 10 and the second power supply module 20 are electrically connected as mentioned in the step S03, the start current A₁ outputted from the first power supply module 10 is used to start the portable 3.5 inch external hard disk 40, and then the first power supply module 10 is replaced by the second power supply module 20 outputting to the start circuit 25.

In the step S05, the main circuit 31 performs data accessing. When the first power supply module 10 and the second power supply module 20 are electrically connected as mentioned in the step S03, the first working current A₂ output from the start circuit 25 of the second power supply module 20 is used to supply the portable 3.5 inch external hard disk 40 to perform data accessing.

The first power supply module 10, the second power supply module 20 and the portable 3.5 inch external hard disk 40 have the same characteristics in the above-mentioned, and the relevant description is thus omitted. For that, the present invention implements the first power supply module 10 inside the portable 3.5 inch external hard disk 40, and does not need to insert into power socket or use 12V power supply to acquire external power such that it is possible to implement the portability and mobility for the portable 3.5 inch external hard disk 40. Additionally, the DC rechargeable battery 110 supplying the first power supply module 10 can reused for many times and thus provides more environmental protection compared with those tradition disposable batteries. Also, the first power supply module 10 can use lower DC voltage to start the portable 3.5 inch external hard disk 40 for less power consumption and carbon reduction. Also, only the PC device 120 is used to provide the power as desired for the portable 3.5 inch external hard disk 40 to continuously perform data access with the advantage like low power and reduced carbon.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A driving system for a portable 3.5 inch external hard disk without using an external power, comprising:
a first power supply module installed in the portable 3.5 inch external hard disk, wherein the first power supply module comprises a first voltage source which generates a start current supplying power to a main circuit, or wherein the first power supply module comprises a second boost circuit generating a start current to supply power to the main circuit;
a second power supply module, comprising a second voltage source, wherein the second voltage source generates a first voltage and a second voltage through a first interface output port and a second interface output port, respectively, and the first voltage and the second voltage are combined to form a voltage which supplies power to a first boost circuit, so that the first boost circuit outputs a first working current to a start circuit; and
the portable 3.5 inch external hard disk, comprising a start circuit and the main circuit electrically connected to the first power supply module and the second power supply module, respectively, so that the start circuit starts the portable 3.5 inch external hard disk through the start current outputted by the first power supply module, and the main circuit performs data accessing through the first working current outputted by the second power module to the start circuit.

2. The driving system as claimed in claim 1, wherein the first power supply module further comprises the second boost circuit connected to the first voltage source, and the second boost circuit boosts the output voltage of the first voltage source to the start current, so that replacing the first power supply module with the second power supply module and supplying power to the main circuit.

3. The driving system as claimed in claim 1, wherein the first voltage source is from a rechargeable DC battery and the second power supply module is from a computer device.

4. The driving system as claimed in claim 3, wherein the computer device is electrically coupled with the portable 3.5 inch external hard disk through a universal serial bus(USB).

5. The driving system as claimed in claim 1, wherein the first output voltage is within 3.7 to 11.1V, or a corresponding current for the first output voltage is within 300 to 500 mA.

6. The driving system as claimed in claim 2, wherein a voltage from the first power supply module to the start current is up to 12V, or a corresponding current is within about 2 to 5 A.

7. The driving system as claimed in claim 1, wherein the first output voltage and the second output voltage are within about 3 to 6V, or corresponding currents for the first and second output voltages are within about 0.9 to 5.0 A.

8. The driving system as claimed in claim 1, wherein the portable 3.5 inch external hard disk further comprises a start circuit, and the second power supply module supplies power to the first power supply module and the main circuit, respectively.

9. The driving system as claimed in claim 8, wherein a voltage of the start circuit is within about 5 to 13V.

10. The driving system as claimed in claim 1, wherein the portable 3.5 inch external hard disk further comprises a second boost circuit, and the second power supply module generates the start current, which supplies power to the main circuit for starting the hard disk.

11. The driving system as claimed in claim 10, wherein the second boost circuit outputs a voltage of within about 5 to 13V.

12. A driving method for a portable 3.5 inch external hard disk without using an external power, comprising the steps of:
providing a first power supply module configured within the portable hard disk, wherein the first power supply module comprises a first voltage source which generates an output start current, or wherein the first power supply module comprises a second boost circuit which generates a start current to supply power to a main circuit for starting the portable hard disk;
providing a second power supply module comprising a second voltage source which outputs a first voltage and a second voltage through a first interface output port and a second interface output port, respectively, the first voltage and the second voltage are combined to form a voltage to a start circuit for supplying power to the main circuit, so that the second voltage source outputs a first working current, replaces the first voltage source and supplies stable current for the portable hard disk to provide disk accessing;
electrically connecting the portable 3.5 inch external hard disk, wherein the portable 3.5 inch external hard disk comprises a start circuit and a main circuit which are electrically connected to the first power supply module and the second power supply module, respectively;
starting the portable 3.5 inch external hard disk, wherein the start circuit starts the portable 3.5 inch external hard disk by the current outputted by the first voltage source; and
performing data accessing to the main circuit, wherein the main circuit performs data accessing by the first working current provided by the second power supply module.

13. The driving method as claimed in claim 12, wherein the first power supply module further comprises a second boost circuit connected to the first voltage source to generate a start current to start the main circuit, so that the second power supply module supplies current to the first power source and the main circuit and stabilizes the portable hard disk.

14. The driving method as claimed in claim 12, wherein the first voltage source is from a rechargeable DC battery and the second voltage source is from a computer device.

15. The driving method as claimed in claim 14, wherein the computer device is electrically coupled with the portable 3.5 inch external hard disk through a universal serial bus(USB).

16. The driving method as claimed in claim 12, wherein the first output voltage is within about 3.7 to 11.7V, or a corresponding current for the first output voltage is within about 2 to 5 A.

17. The driving method as claimed in claim 13, wherein a working voltage of the second power supply module is up to 12V, or a corresponding current is within 300 to 500 mA.

18. The driving method as claimed in claim 12, wherein the first output voltage and the second output voltage are within about 3.7 to 12V, or corresponding currents for the first and second output voltages are within about 300 to 500 mA.

19. The driving method as claimed in claim 12, wherein the portable 3.5 inch external hard disk further comprises the first power supply module, the second power supply module and the start circuit, and the second power supply module supplies power to the first power supply module and charges power to the main circuit, respectively.

20. The driving method as claimed in claim 19, wherein a voltage of the power supply module is within about 3.7 to 13V.

21. The driving method as claimed in claim 12, wherein the portable 3.5 inch external hard disk further comprises a first boost circuit and the second boost circuit, and the second power supply module supplies power to the main circuit and the second boost circuit, respectively.

22. The driving method as claimed in claim 21, wherein a voltage outputted by the second boost circuit is within about 3.7 to 13V.
